(19) United States
(12) Patent Application Publication
(10) Pub. No.: US 2010/0115276 A1
(43) Pub. Date: May 6, 2010

(54) SYSTEM AND METHOD FOR DERIVATING DETERMINISTIC BINARY VALUES

(75) Inventors: Pierre Betouin, Boulogne (FR); Mathieu Ciet, Paris (FR); Augustin J. Farrugia, Cupertino, CA (US)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/263,357

(22) Filed: Oct. 31, 2008

(51) Int. Cl. H04L 9/32; G06T 11/20

(52) U.S. Cl. 713/169; 345/440

(57) ABSTRACT

Disclosed herein are systems, computer-implemented methods, and computer-readable media for deriving a deterministic binary value. The method consists of generating a graph from multiple inputs, formalizing the graph, calculating paths between starting and ending nodes in the graph using a shortest path algorithm and performing a digest operation based on the derived paths to generate a deterministic binary value. In another aspect of this disclosure, authentication is performed utilizing deterministic binary values and a graph-merging function. This method allows for diversity in complexity, thus maintaining security on different computer platforms.

### BACKGROUND OF THE INVENTION

1. Field of the Invention

The present invention relates to Digital Rights Management (DRM) and more specifically to authentication using generated graphs to perform digest operations and to generate a deterministic binary value.

2. Introduction

Protection of digital content is important for many enterprises. Enterprises attempt to secure this protection by implementing DRM in one form or another. DRM software uses various protection means to secure digital content (music, video, applications, etc.).

Authentication plays an important role in computer security. Authentication is the process of verifying the digital identity of the sender of a communication. In some cases, this is a mutual authentication. Many processes for authenticating an entity are known in the art, such as Extensible Authentication Protocol (EAP) and its many method variations (EAP-MD5, EAP-OTP, EAP-GTC, EAP-TLS, EAP-IKEv2, EAP-SIM, and EAP-AKA).

Including seemingly random variables in the authentication process plays an important role in keeping the system secure. Advancing technology and more sophisticated hacking techniques require authentication processes that efficiently produce signatures with unique and more random approaches.

To keep computer systems secure, it would be beneficial to diversify the complexity of software protection. This would allow for different levels of complexity depending on the architecture the software runs on. Accordingly, what is needed in the art is an improved way to diversify the complexity of software protection.

### SUMMARY

Additional features and advantages of the invention will be set forth in the description which follows, and in part will be obvious from the description, or may be learnt by practice of the invention. The features and advantages of the invention may be realized and obtained by means of the instruments and combinations particularly pointed out in the appended claims. These and other features of the present invention will become more fully apparent from the following description and appended claims, or may be learnt by the practice of the invention as set forth herein.

Disclosed are systems, computer-implemented methods, and tangible computer-readable media such as computer memory for performing authentication utilizing deterministic binary values and graphs. Authentication is performed on a sender by generating a first graph generated from a plurality of input values, sending the first graph and a plurality of input values to a receiver, generating a second graph generated from a plurality of input values, generating a third graph by merging the first and second graphs, deriving paths between starting and ending nodes in the third graph using a shortest path algorithm, performing digest operations based on the derived paths to generate deterministic binary values, and utilizing the generated deterministic binary values to perform authentication.

Authentication is performed on a receiver by receiving a first graph, which is the same as the first graph on the sender side, and a plurality of input values from a sender, generating a second graph from a plurality of input values on the receiver, generating a third graph, which is the same as the third graph on the sender side, by merging the first and second graphs, deriving paths between starting and ending nodes in the sixth graph using a shortest path algorithm, performing digest operations based on the derived paths to generate deterministic binary values, and utilizing the generated deterministic binary values to perform authentication. Graphs one, two and three on the receiver side are the same as graphs one, two, and three on the server side. In the end, both the sender and the receiver share the same information in their own local versions of the graph.

In another aspect of this disclosure, a method for deriving a deterministic binary value that is complex, hard to recover, irreversible and unique is presented. Deriving a deterministic binary value is performed by generating a graph from a plurality of input values, formalizing the graph, deriving paths between pairs of starting and ending nodes in the graph using a shortest path algorithm, and performing a digest operation based on the derived paths to generate a deterministic binary value.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2A illustrates an example non-oriented graph in visual form;

FIG. 2B illustrates the graph data shown in FIG. 2A in table form;

FIG. 3A illustrates authentication utilizing deterministic binary values on a sender;

FIG. 3B illustrates authentication utilizing deterministic binary values on a receiver;

FIG. 3C illustrates a unified view of FIGS. 3A and 3B as well as visual graph representations;

FIG. 4 illustrates the graph generation process;

FIG. 5A illustrates the process of determining the number of children per node in a graph;

FIG. 5B illustrates picking a number in a range;

FIG. 5C illustrates a function uniformly generating numbers in a range;

FIG. 6A illustrates the process of determining children for each node in a graph;

FIG. 6B illustrates picking a value in a range not in a list;

FIG. 7 illustrates updating the children of each node in a graph; and

FIG. 8 illustrates generating a deterministic binary value.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

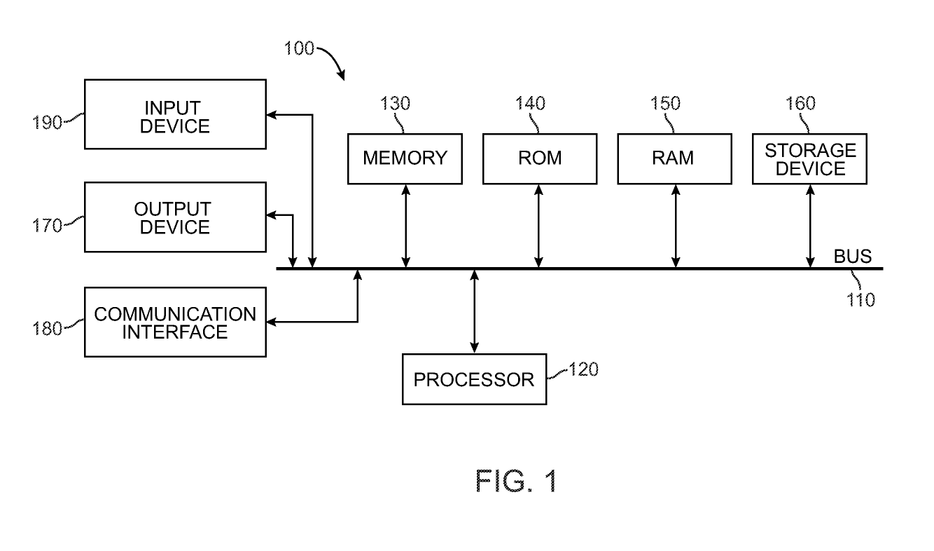

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. A processing unit 120 can include a general purpose CPU controlled by software as well as a special-purpose processor. Of course, a processing unit includes any general purpose CPU and a module configured to control the CPU as well as a special-purpose processor where software is effectively incorporated into the actual processor design. A processing unit may essentially be a completely self-contained computing system, containing multiple cores or CPUs, a bus, memory controller, cache, etc. A multi-core processing unit may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software and hardware, such as a processor, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

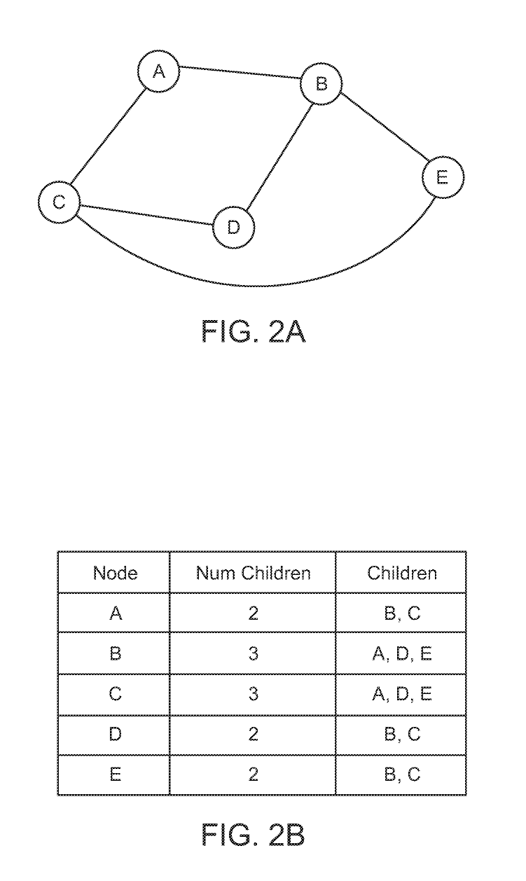

A graph is a collection of nodes connected by links, with the exception of a null graph which has no nodes and, by extension, no links. Nodes are also called vertices or points. Links are also called edges, lines, or points. Links can include an orientation. When links include orientation, a link from A to B is distinct and different from a link from B to A. Links can include also include a weight or cost. FIG. 2A illustrates a visual representation of an example graph comprised of five nodes with links connecting the nodes. FIG. 2B describes the graph in the form of a table of connections. Nodes are labeled A-E. The number of children of a node is defined as the number of different nodes a particular node connects to. For instance, node A has two children since it has connections or links to nodes B and C. Node B has three children since it has links to nodes A, D and E. Graphs have different properties, for instance oriented vs. non-oriented. An oriented graph is a graph whose links contain direction between two nodes. A non-oriented graph has links that do not indicate direction. Graphs are utilized in the authentication process disclosed herein. FIG. 2A illustrates a non-oriented graph. An oriented graph can be depicted with arrows showing directionality. A graph with weighted links can be denoted with a label indicating weight for each link. While the graph shown in FIG. 2A has multiple cycles, or closed paths, the graph can be completely linear and acyclical (such as a linked list), or hierarchical (such as a binary or ternary tree). The principles of the invention do not depend on any particular type of graph. In fact, in some circumstances, different types of graphs can provide enhanced security and complexity. Nodes in the graph can link to themselves even though such links would be useless in calculating a shortest path between two unique nodes. Such self-referencing links can serve to add complexity to frustrate and/or confuse any reverse engineering attempts or security tampering attempts.

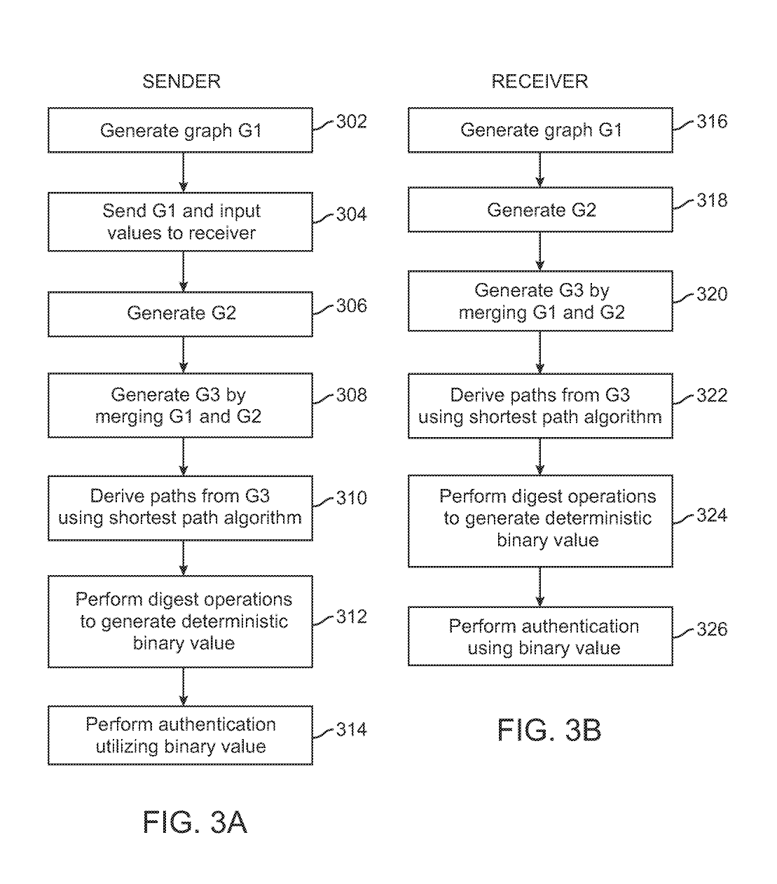

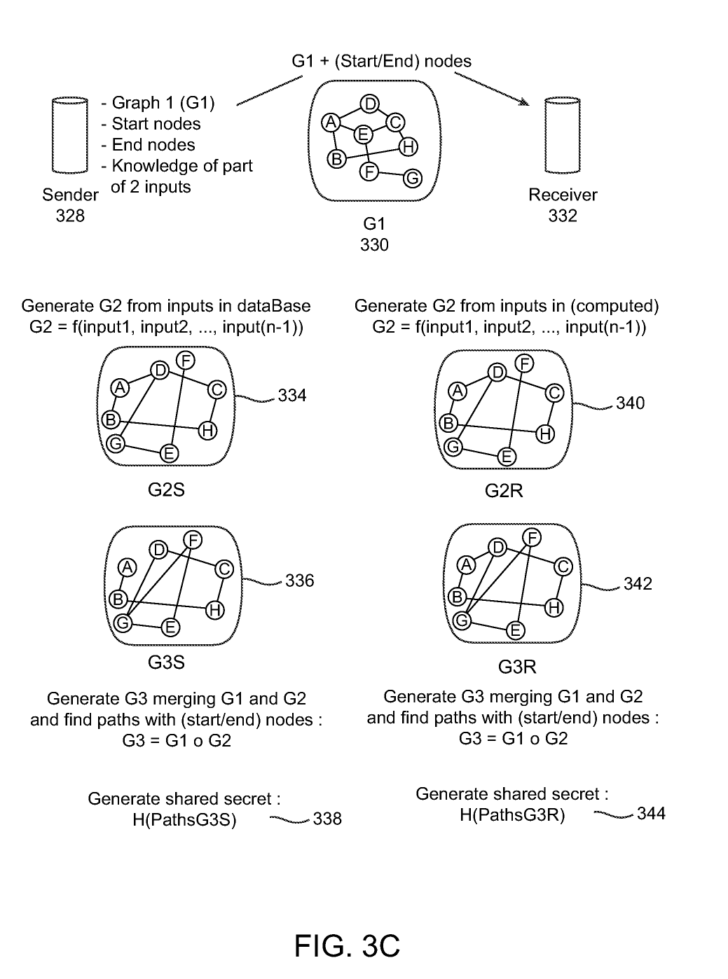

FIGS. 3A and 3B are companions and illustrate parallel processes on two corresponding entities. For example, a sender practices the steps shown in FIG. 3A, and a receiver practices the steps shown in FIG. 3B. The various graphs referenced in FIGS. 3A and 3B are parallel. The first graphs G1 in FIGS. 3A and 3B contain the same information. The second graphs, G2, are generated using the same inputs and contain the same information. Merging G1 with G2 results in the same shared graph on both the sender and the receiver, G3. FIG. 3C provides a unified, merged view of the processes depicted in FIGS. 3A and 3B as well as visual representations of the various graphs. FIG. 3A illustrates a method that performs authentication utilizing deterministic binary values on a sender. A deterministic binary value is a binary value in which no randomness is used to determine the value. A binary value can be represented by any sequence of bits (binary digits). The method is described as being performed by a system, which can be any kind of electronic device. The system generates a graph G1 and determines starting and ending nodes within the graph (302). The system sends the graph and starting and ending nodes to a receiver (304). The system generates a second graph G2 based on values already known to the sender (306). The system then generates a third graph G3 by merging graphs G1 and G2 (308). After the third graph is generated, the system derives paths through G3 using a shortest path algorithm (310). The system can employ any of the many different shortest path algorithms known by those of skill in the art. Utilizing the paths derived in step 310, the system performs digest operations to generate a deterministic binary value (312). The system then authenticates using the generated binary value (314).

FIG. 3B illustrates a method that performs authentication utilizing deterministic binary values on a receiver. The method is described as being performed by a system, which can be any kind of electronic device. The system first receives a graph G1 and starting and ending nodes from a sender (316). The system generates a second graph G2 based on values already known to the receiver (318). Such values may be exchanged in advance between a sender and receiver. The system then generates a third graph G3 by merging graphs G1 and G2 (320). After G3 is generated, the system derives paths from G3 using a shortest path algorithm (322). Utilizing the paths derived in step 322, the system performs digest operations to generate a deterministic binary value (324). The generated binary value is then used in authentication (326).

FIGS. 3A and 3B illustrate systems for authentication utilizing deterministic binary values. Such systems may be, for example, a desktop computer, a server, a portable device, or any combination thereof. In some embodiments, portions of the method are performed on one device and other portions are performed on other device(s). An exemplary system includes a module configured to generate a first graph from a first plurality of input values on a sender; a module configured to send the first graph and a second plurality of values to a receiver; a module configured to generate a second graph from a third plurality of input values on the sender; a module configured to generate a third graph by merging the first and second graphs on the sender; a module configured to derive a shortest path between the starting and ending nodes in the third graph using a shortest path algorithm; a module configured to perform digest operations based on the derived set of paths to generate a deterministic binary value on the sender; and a module configured to utilize the generated deterministic binary value to perform authentication between the sender and the receiver on the sender side. In another example, a system includes: a module configured to generate a second graph from a third plurality of input values on the receiver; a module configured to generate a third graph by merging the first and second graphs on the receiver; a module configured to derive a set of paths between starting and ending nodes in the third graph using a shortest path algorithm on the receiver; a module configured to perform digest operations based on the derived set of paths to generate a deterministic binary value on the receiver; and a module configured to utilize the generated deterministic binary value to perform authentication between the sender and the receiver.

As stated above, FIG. 3C provides a unified, merged view of the processes depicted in FIGS. 3A and 3B as well as visual representations of the various graphs. The sender 328, whose steps are outlined in FIG. 3A, starts with a graph G1 330, starting nodes, and ending nodes. The sender transmits G1 330 to the receiver 332, whose steps are outlined in FIG. 3B. The sender 328 generates graph G2S (so named because it is graph 2 on the sender side) from inputs in a database. The sender merges G1 330 and G2S 334 to generate a shared graph G3S 336. The sender uses G3S to generate a shared secret 338 which should be the same as the one generated by the receiver. Meanwhile, the receiver 332 generates a graph G2R 340 (so named because it is graph 2 on the receiver side) from inputs received from the sender 328. The receiver 332 merges G1 330 with G2R 340 to generate a shared graph G3R 342. The receiver uses G3R to generate a shared secret 344 which should be the same as the one generated by the sender. When these two shared secrets match, the sender and/or the receiver can be certain of the other's identity and/or authorization.

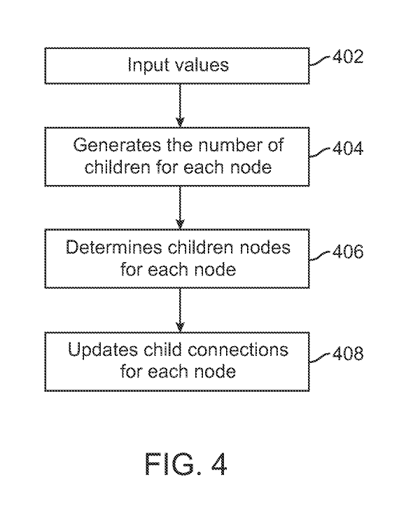

FIG. 4 illustrates the graph generation process utilized on both the sender and receiver sides of the authentication scheme (see FIG. 3A and 3B). Given a set of input values (402), a unique graph is generated corresponding to the input values. The unique graph is built by uniquely mapping a set of values with a set of nodes and links between those nodes. The graph input values can be any data value such as integers, strings, and arrays. In the next step in the graph generation process, the system generates the number of children for each node (404). The system determines children nodes for each node (406) and updates the child connections for each node (408).

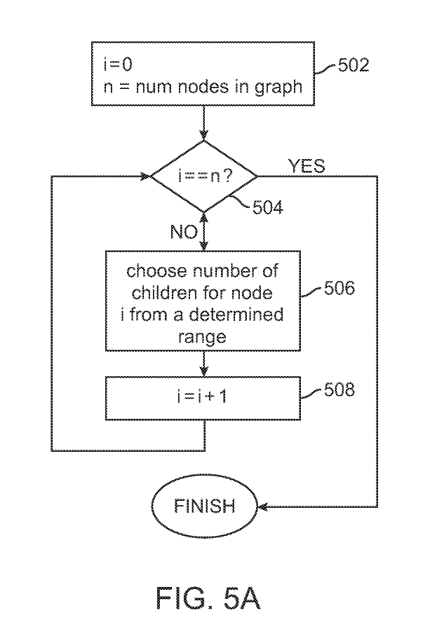

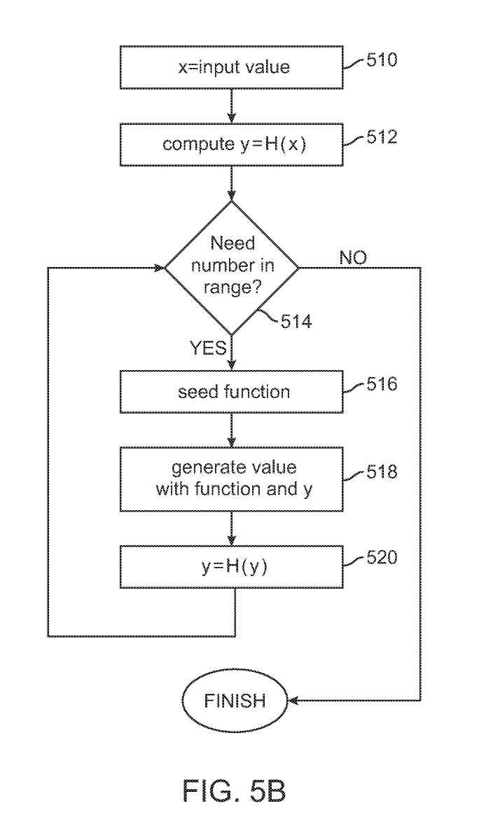

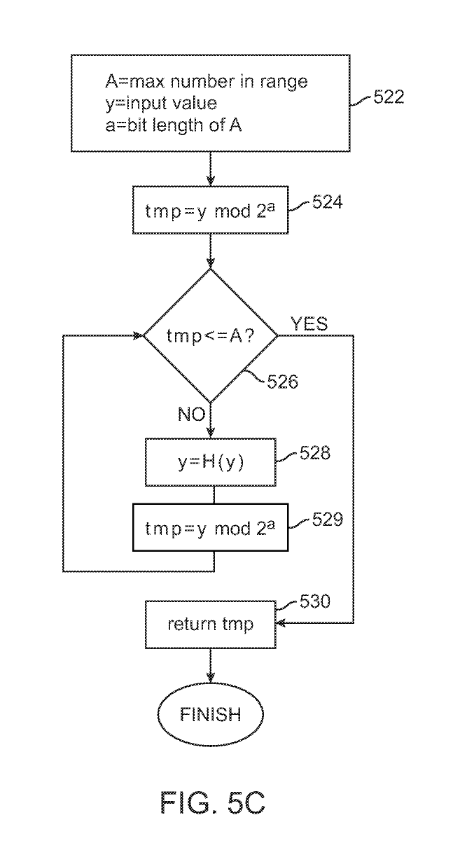

FIG. 5A illustrates a method embodiment of step (404) in the graph generation process (generating the number of children for each node). In this example, the number of nodes in the graph, the minimum number of children and maximum number of children are fixed values. The system initializes the variables i to equal 0 and n to equal the number of nodes in the graph (502). The system tests the condition governing the loop. If index i does not equal n, the system continues to step 506, wherein the system chooses the number of children for node i in a determined range (506). The system increments i by 1 (508) and returns to test the loop condition (504). If i does equal n, the process is complete. Note that the timing performances and the security level of the paths search depends on the number of nodes and the number of links for each node, and these can be adjusted accordingly.

FIG. 5B illustrates a method embodiment of choosing a number in a determined range, as is illustrated in step 506 in FIG. 5. The system initializes the variable x as an input value, specifically a personal identifier (510). The system computes the value Y by setting it equal to H(x), wherein H is a one-way function, for instance a hash function (512). The system tests the condition, to determine if another value is needed (514). If another value is not needed, the process is complete. If another value is needed, a function that is able to uniformly generate a value within the range {0, . . . , B} with Y is seeded, or initialized (516). The system generates a value in the range using the function that uniformly generates a value in the range (518). The value Y is updated as H(Y), in preparation for the next round of generating a value (520). When the process is complete, a value in a range has been chosen.

FIG. 5C illustrates an exemplary method embodiment of a function that uniformly generates numbers in the range {0, . . . , A}, from a value Y. The value A is initialized to the maximum number in the range, Y is an input value and a is the bit length of A or number of bits in A (522). The system sets the variable tmp equal to Y mod 2^{a} (524). The system then tests the condition governing the loop (526). If tmp is less than or equal to A, the system proceeds to the next step (530) and returns tmp. If tmp is greater than A, the system proceeds to the next step (528) and sets Y=H(Y) where H is a one-way function, for instance a hash. The system then sets the variable tmp equal to Y mod 2^{a} (529) as in step (524). The system returns to step 524 and continues the process until tmp is greater than A, when the process is complete. Note that picking a value in the range {A, . . . , B} is equivalent to picking a value in the range {0, . . . , (B-A)} and adding A to the chosen value. This process has the advantage of being deterministic and introducing no bias.

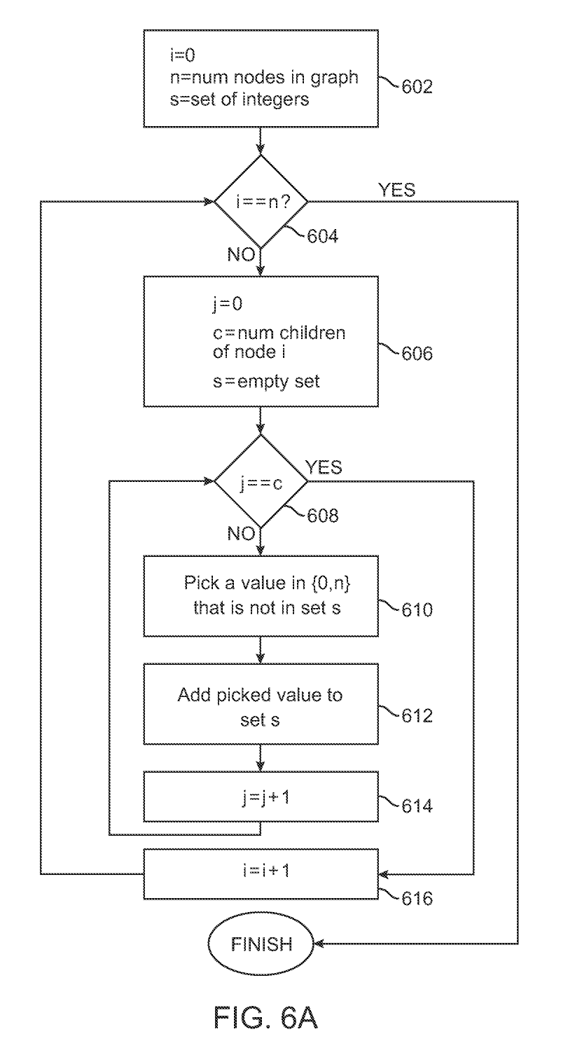

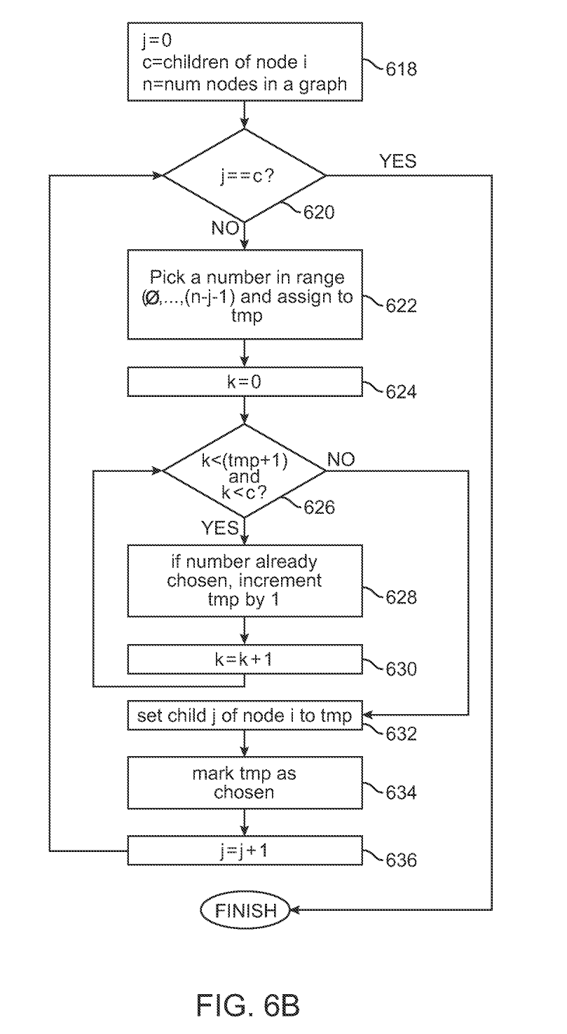

FIG. 6A illustrates the method embodiment of generating children for each node in the graph. The system initializes the index i to 0, n to the number of nodes in the graph and S as an empty set (602). The system tests the first condition, if i is equal to n (604). If i is not equal to n, j is initialized to 0, c is initialized to the number of children of node i, and S as the empty set (606). The system tests the second condition, if j is equal to c (608). If j is not equal to c, the system picks a value in the range {0, n} that is not in the set S (610). The picked value is added to the set S (612). The index j is incremented by 1 (614) and the system returns to the condition testing the index j (608). If j is equal to c, the index i is incremented by 1 (616) and the system returns to the condition testing the index i (604). If i is equal to n, the process is complete. At this point, children have been determined for each node in the graph.

FIG. 6B illustrates the method embodiment of picking a value in a range that is not in a list. This function is used in step 610 in FIG. 6A when generating children for each node in a graph. The system initializes index j to 0, c to the number of children of a particular node and n as the number of nodes in the graph (618). The system tests the loop condition (620). If j is not equal to c (or all the children of a node have not been determined), the system picks a number in the range {0, . . . , (n-j)} and assigns it to the variable tmp (622). The system initializes index k to 0 (624) and tests the second loop condition (626). If k is less than tmp plus one and k is less than c, the system checks if the number has already been chosen from the list, and if so increments the value tmp by 1 (628). The system increments k by 1 (630) and returns to the condition on the loop (626). If k is not less than tmp plus 1 or k is not less than c, the system proceeds to set the child of j of node i equal to tmp (632). The system then marks the value tmp as chosen (634) and increments index j by 1 (636). The system returns to the condition on the loop (620). If j equals c, the process is complete. The process is complete once all of the children for a given node have been assigned unique values.

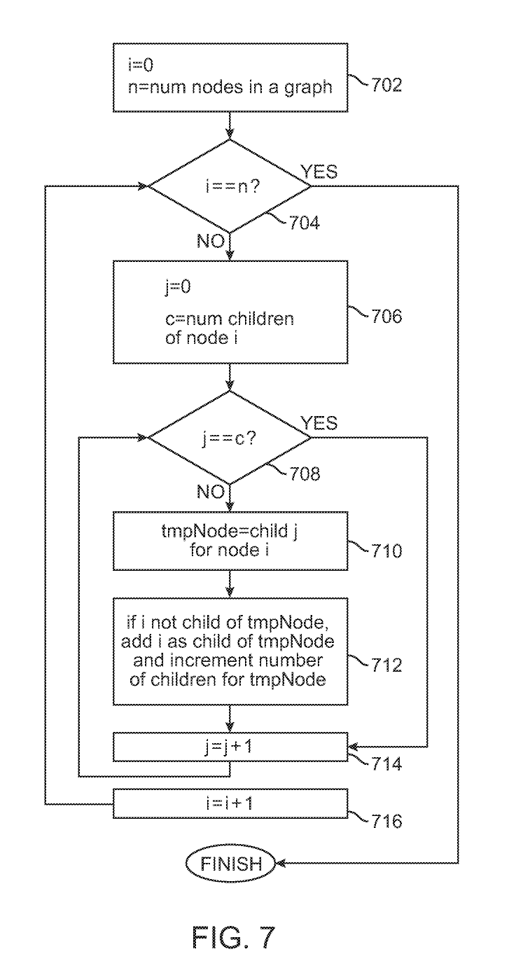

FIG. 7 illustrates a method embodiment of updating the children for each node. The system initializes index i to 0 and n to the number of nodes in the graph (702). The system tests the loop condition (704). If i is not less than n, the system initializes j to 0 and c to the number of children of node i (706). The system tests a second loop condition (708). If j does not equal c, the variable tmpNode is initialized as the child j of node i (710). The system checks if i is listed as a child of tmpNode, and if not it adds i as a child of tmpNode and increments the number of children of tmpNode by one (712). The system increments j by 1 (714) and returns to the condition on the loop (708). If j is equal to c (or all the children of node i have been processed), the system increments index i by one (716) and returns to the condition on the loop (704). If i equals n, all the nodes in the graph have been updated, and the process is complete. The process is necessary in non-oriented graphs since when two nodes are connected, each node of that connection is a child of the other. For instance, if nodes 1 and 3 are connected by a link, 3 is a child of 1 and 1 is a child of 3. This process is necessary on both oriented and non-oriented graphs.

The generated graph has the following properties: the number of links or children per node is not greater than the logarithm of the number of nodes in the graph; the number of children per node lands in a determined range; and the nodes are all connected. The number of nodes in a graph is adjusted based on a complexity limitation. Note that the details in the graph generation process are exemplary, and variants exist, for instance there could be a fixed number of connections for each node, a variable number of nodes in the graph, the graph could be oriented, nodes and links can have different weights, etc.

In the proposed authentication scheme, the “addition” or merge of two graphs is necessary (308, 320). The merge of two graphs is performed as a logical OR operation on the child connections of each node. Given a graph G1 and G2 with the same number of nodes and a variable number of children, the merge graph is the addition of the children of G2 which are not in G1. For a given node, if G1 and G2 have a common link to a child, the merge graph will also have a link to this child.

The system can use any shortest-path algorithm known in the art to calculate the shortest path through the graph between the starting and ending nodes (310, 322). In graph theory, the shortest path problem is the problem of finding a path between two nodes such that the sum of the weights of the links is minimized. The system can weight links uniformly (such as with a weight of 1) or with different weights to add complexity. One well-known shortest path algorithm is Dijkstra's algorithm that solves the single-source shortest path problem for a graph with non-negative links, and outputs a shortest path tree. For the proposed authentication scheme, any shortest path algorithm will do.

After the shortest paths for couples of starting and ending nodes are determined for a given graph, the system performs a digest operation or function (312, 324). The operation can be a SHA1, SHA2, a HMAC or any other function able to produce a digest. An HMAC is a type of message authentication code (information used to authenticate a message) calculated using an algorithm involving a cryptographic hash function and a secret key. A cryptographic hash function is a function that takes input and returns a fixed-sized string, called the hash value, message digest, digital fingerprint or a checksum. The digest takes as input the derived shortest paths and produces an expanded output. The expanded output is the generated deterministic value used in authentication (314, 326). This is a “one way function” meaning that function is simple to calculate and “hard” to invert, meaning that no known probabilistic polynomial-time algorithm can compute the function.

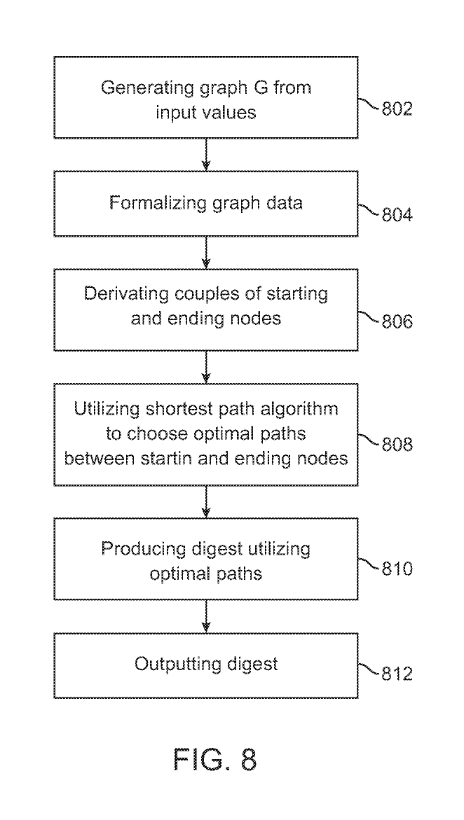

In another aspect of this disclosure, generating a deterministic binary value that is complex, hard to recover, irreversible and unique is disclosed. FIG. 8 illustrates a method embodiment of generating a deterministic binary value. The method includes: generating a graph G from input values (802); formalizing the graph information in an appropriate way (804); calculating numerous pairs of starting and ending nodes (806); utilizing a flexible shortest path algorithm to choose the optimal paths through the graph between a pair of start and end points (808); choose the optimal paths for all pairs by performing a digest operation utilizing the optimal paths to produce a digest, or deterministic binary value (810) and outputting the digest (812). The shortest path algorithm is flexible in that it can be changed according to performance needs and scalability. The digest operation can be a SHA1, SHA2, a HMAC or any other function able to produce a digest.

In the proposed authentication scheme, different aspects of the algorithm can be changed depending on performance needs and scalability, hence diversifying the complexity of software protection. A flexible shortest path algorithm is utilized, meaning that the particular algorithm to determine the shortest path may be changed. The number of couples of starting and ending nodes to derive paths utilized in 310 and 322 must be greater than a number fixed in accordance with performance needs and architecture. The number of nodes in a graph is adjusted based on a complexity limitation. Each of these aspects is exemplary and should not be limiting in any way.

The authentication method disclosed herein can be combined in whole or in part with other known authentication schemes. For example, the system can be combined with a biometric authentication module or with a username and password authentication module. When implemented as a computer system, the representations of the graphs, nodes, and links in computer memory can be obfuscated using one or more techniques to enhance the difficulty of reverse engineering attempts.

Embodiments within the scope of the present invention may also include computer-readable media for carrying or having computer-executable instructions or data structures stored thereon. Such computer-readable media can be any available media that can be accessed by a general purpose or special purpose computer, including the functional design of any special purpose processor as discussed above. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, data structures, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the invention. For example, the principles herein may be applied to generating a deterministic binary value for other uses than authentication. Those skilled in the art will readily recognize various modifications and changes that may be made to the present invention without following the example embodiments and applications illustrated and described herein, and without departing from the true spirit and scope of the present invention.

We claim:

1. A computer-implemented method of authentication using graphs comprising of a plurality of nodes and a plurality of links connecting the plurality of nodes, the method comprising:
generating a first graph from a first plurality of input values;
sending the first graph and a second plurality of values to a receiver;
generating a second graph from a third plurality of input values;
generating a third graph by merging the first and second graphs;
calculating a set of paths between starting and ending nodes in the third graph using a shortest path algorithm;
performing digest operations based on the derived set of paths to generate a deterministic binary value; and
utilizing the generated deterministic binary value to perform authentication between the sender and the receiver.

2. The computer-implemented method of claim 1, wherein a number of couples of starting and ending nodes within a respective graph is greater than a minimum complexity threshold.

3. The computer-implemented method of claim 1, wherein a number of nodes in a respective graph falls within a determined range.

4. The computer-implemented method of claim 1, wherein a number of links connected to any particular node in a respective graph is not greater than the mathematical logarithm of the number of nodes in the respective graph.

5. The computer-implemented method of claim 1, wherein a graph is oriented.

6. The computer-implemented method of claim 1, wherein a graph is non-oriented.

7. The computer-implemented method of claim 1, wherein nodes and links within a graph have equal weights.

8. The computer-implemented method of claim 1, wherein nodes and links within a graph do not have equal weights.

9. The computer-implemented method of claim 1, wherein all nodes in a graph are connected.

10. A computer-implemented method of authentication using graphs comprising of a plurality of nodes and a plurality of links connecting the plurality of nodes, the method comprising:
receiving a first graph from a first plurality of input values;
generating a second graph from a third plurality of input values;
generating a third graph by merging the first and second graphs;
deriving a set of paths between starting and ending nodes in the third graph using a shortest path algorithm;
performing digest operations based on the derived set of paths to generate a deterministic binary value; and
utilizing the generated deterministic binary value to perform authentication between the sender and the receiver.

11. The computer-implemented method of claim 10, wherein a number of couples of starting and ending nodes within a respective graph is greater than a minimum complexity threshold.

12. The computer-implemented method of claim 10, wherein a number of nodes in a respective graph falls within a determined range.

13. The computer-implemented method of claim 10, wherein a number of links connected to any particular node in a respective graph is not greater than the mathematical logarithm of the number of nodes in the respective graph.

14. The computer-implemented method of claim 10, wherein a graph is oriented.

15. The computer-implemented method of claim 10, wherein a graph is non-oriented.

16. The computer-implemented method of claim 10, wherein nodes and links within a graph have equal weights.

17. The computer-implemented method of claim 10, wherein nodes and links within a graph do not have equal weights.

18. The computer-implemented method of claim 10, wherein all nodes in a graph are connected.

19. A system for authentication utilizing deterministic binary values, the system comprising:
a module configured to generate a first graph from a first plurality of input values;
a module configured to send the first graph and a second plurality of values to a receiver;
a module configured to generate a second graph from a third plurality of input values;
a module configured to generate a third graph by merging the first and second graphs;
a module configured to derive a set of paths between starting and ending nodes in the third graph using a shortest path algorithm;
a module configured to perform digest operations based on the derived set of paths to generate a deterministic binary value; and
a module configured to utilize the generated deterministic binary value to perform authentication between the sender and the receiver.

20. A system for authentication utilizing deterministic binary values, the system comprising:
a module configured to receive a first graph from a first plurality of input values;
a module configured to generate a second graph from a third plurality of input values;
a module configured to generate a third graph by merging the first and second graphs;
a module configured to derive a set of paths between starting and ending nodes in the third graph using a shortest path algorithm;
a module configured to perform digest operations based on the derived set of paths to generate a deterministic binary value; and
a module configured to utilize the generated deterministic binary value to perform authentication between the sender and the receiver.
